(19) United States
(12) Patent Application Publication
(10) Pub. No.: US 2026/0113223 A1
(43) Pub. Date: Apr. 23, 2026

(54) APPARATUS AND METHOD FOR PROVIDING STREAMING BY USING DATA FOR EACH FREQUENCY

(71) Applicant: UNDERMILI INC., Chuncheon-si (KR)

(72) Inventor: Ho Joung LEE, Hwaseong-si (KR)

(21) Appl. No.: 19/424,165

(22) Filed: Dec. 18, 2025

Related U.S. Application Data
(63) Continuation of application No. PCT/KR2024/016724, filed on Oct. 30, 2024.

(30) Foreign Application Priority Data
Oct. 31, 2023 (KR) 10-2023-0147614

(51) Int. Cl. H04L 25/49

(52) U.S. Cl. CPC H04L 25/49

(57) ABSTRACT

An apparatus and a method for providing streaming by using data for each frequency are disclosed. The method for providing streaming by using data for each frequency according to an exemplary embodiment of the present disclosure includes the steps of: converting an input signal into a signal for each frequency; and transmitting target data in the form of a stream including the signal for each frequency to a main server for providing streaming for a client terminal.

### DESCRIPTION

### TECHNICAL FIELD

The present disclosure relates to an apparatus and a method for providing streaming by using data for each frequency.

### BACKGROUND ART

Generally, analog sensor data is converted to digital data by means of pulse-code modulation (PCM) to be transmitted and received and with regard to this, FIG. 1 is a conceptual view illustrating a pulse-code modulation (PCM) scheme of the related art.

Referring to FIG. 1, a pulse-code modulation (PCM) scheme is a digital code scheme which converts a magnitude of an analog signal into a code string with a fixed length and corresponds to a representative scheme which converts an analog signal having a temporal continuity into a discrete digital signal. Generally, an analog signal is extracted as much as a clock cycle to be sampled, and then quantized into a numerical value and is encoded into a binary bit string corresponding to the value.

In the meantime, from the viewpoint of data processing, like a signal to which Fourier transform is applied, most processing utilizes data for each frequency and to be more specific, a processing operation, such as data compression and inference using a deep learning model, is generally performed based on data for each frequency.

Accordingly, during the processing using data for each frequency, a task for hardware further needs to perform a task of transforming PCM data to which pulse code modulation is applied into data for each frequency so that a time delay occurs and it becomes a burden on hardware which performs data transformation. Specifically, PCM data is not appropriate for a processing technique, such as deep learning, loss stream data recovery or graphics processing unit (GPU)-based data processing.

A related art of the present disclosure is disclosed in Korean Registered Patent Publication No. 10-1401430.

### DISCLOSURE

### Technical Problem

In order to solve the problems of the related art described above, an object of the present disclosure is to provide an apparatus and a method for providing streaming by using data for each frequency which directly utilizes data for each frequency converted from an analog signal as stream data.

However, objects to be achieved by the exemplary embodiments of the present disclosure are not limited to the technical objects as described above and other technical objects may be present.

### Technical Solution

As a technical means to achieve the above-described technical object, according to an aspect of the present disclosure, a method for providing streaming by using data for each frequency may include converting an input signal into a signal for each frequency; and transmitting target data in the form of stream including the signal for each frequency to a main server for providing streaming for a client terminal.

Further, the target data may be transmitted from the main server to the client terminal to be reconstructed as an analog signal.

Further, the step of converting may include a step of sampling a sensor signal generated by a sensor provided to measure an analog signal into a digital signal using an analog-to-digital converter.

Further, the step of converting may further include a step of applying pulse-code modulation (PCM) to the digital signal; and a step of performing a reference transform to decompose a signal to which the pulse-code modulation is applied to a component according to a predetermined frequency band.

Further, the reference transform may include short-time Fourier transform (STFT).

Further, the step of converting may further include a step of allowing the digital signal to pass through a signal conversion filter which derives the signal for each frequency, by using the digital signal.

Further, in the step of converting, the signal for each frequency may be generated based on a result of measuring a magnitude for each frequency band of the input signal which is generated by passing through a sensor provided so as to respond to each of the plurality of predetermined frequency bands.

The method for providing streaming by using data for each frequency according to an exemplary embodiment of the present disclosure may further include, before the step of transmitting to the main server, a step of performing preprocessing on the target data to remove a noise component.

Further, the main server may apply a predetermined signal processing algorithm to the target data to be transmitted to the client terminal.

When the signal processing algorithm is applied, the reference transform which decomposes the target data into a component according to each frequency band may be omitted.

The client terminal may apply a predetermined signal processing algorithm to the target data received from the main server.

According to another aspect of the present disclosure, an apparatus for providing streaming by using data for each frequency may include a data converter which converts an input signal into a signal for each frequency; and a data transmitter which transmits target data in the form of stream including the signal for each frequency to a main server for providing streaming for a client terminal.

Further, the data converter may sample a sensor signal generated by a sensor provided to measure an analog signal into a digital signal using an analog-to-digital converter.

Further, the data converter may apply pulse-code modulation (PCM) to the digital signal, and then perform a reference transform which decomposes a signal to which the pulse-code modulation is applied into a component according to a predetermined frequency band, or allow the digital signal to pass through the signal conversion filter which derives the signal for each frequency using the digital signal.

The above-described solving means are merely illustrative but should not be construed as limiting the present disclosure. In addition to the above-described exemplary embodiments, additional exemplary embodiments may be further provided in the drawings and the detailed description of the present disclosure.

### Advantageous Effects

According to the above-described technical solution of the present disclosure, an apparatus and a method for providing streaming by using data for each frequency which directly utilize data for each frequency converted from an analog signal as stream data may be provided.

According to the above-described technical solution of the present disclosure, a signal control efficiency may be increased in various fields which use pulse-code modulation (PCM) data based on analog sensor data, such as autonomous driving sensors, audios, and videos.

According to the above-described technical solution of the present disclosure, hardware load and latency in each step for data processing may be improved.

According to the above-described technical solution of the present disclosure, a software processing time for providing data streaming to a client terminal may be efficiently used.

However, the effect which can be achieved by the present disclosure is not limited to the above-described effects, there may be other effects.

### DESCRIPTION OF DRAWINGS

FIG. 1 is a conceptual view illustrating a pulse-code modulation (PCM) scheme of the related art.

FIG. 2 is a schematic diagram of a streaming providing system according to an exemplary embodiment of the present disclosure.

FIG. 3 is a conceptual view illustrating an operation process of a streaming providing apparatus using data for each frequency according to an exemplary embodiment of the present disclosure.

FIG. 4 is a conceptual view for explaining a process of converting an analog input signal into a signal for each frequency.

FIG. 5 is a conceptual view for explaining stream type target data including a converted signal for each frequency.

FIG. 6 is a conceptual view for explaining a streaming providing process using target data.

FIG. 7 is a schematic diagram of a streaming providing apparatus using data for each frequency according to an exemplary embodiment of the present disclosure.

FIG. 8 is an operation flowchart for a streaming providing method using data for each frequency according to an exemplary embodiment of the present disclosure.

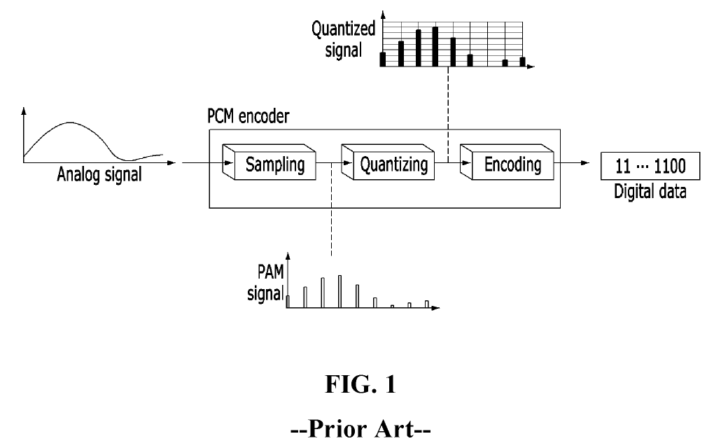

### Best Mode

Hereinafter, the present disclosure will be described more fully with reference to the accompanying drawings, in which exemplary embodiments of the present disclosure are shown. However, the present disclosure can be realized in various different forms, and is not limited to the exemplary embodiments described herein. Accordingly, in order to clearly explain the present disclosure in the drawings, portions not related to the description are omitted. Like reference numerals designate like elements throughout the specification.

Throughout this specification and the claims that follow, when it is described that an element is “coupled” to another element, the element may be “directly coupled” to the other element or “electrically coupled” or “indirectly coupled” to the other element through a third element.

Through the specification of the present disclosure, when one member is located “on”, “above”, “on an upper portion”, “below”, “under”, and “on a lower portion” of the other member, the member may be adjacent to the other member or a third member may be disposed between the above two members.

Through the specification of the present disclosure, unless explicitly described to the contrary, the word “comprise” and variations such as “comprises” or “comprising”, will be understood to imply the inclusion of stated elements but not the exclusion of any other elements.

The present disclosure relates to an apparatus and a method for providing streaming by using data for each frequency.

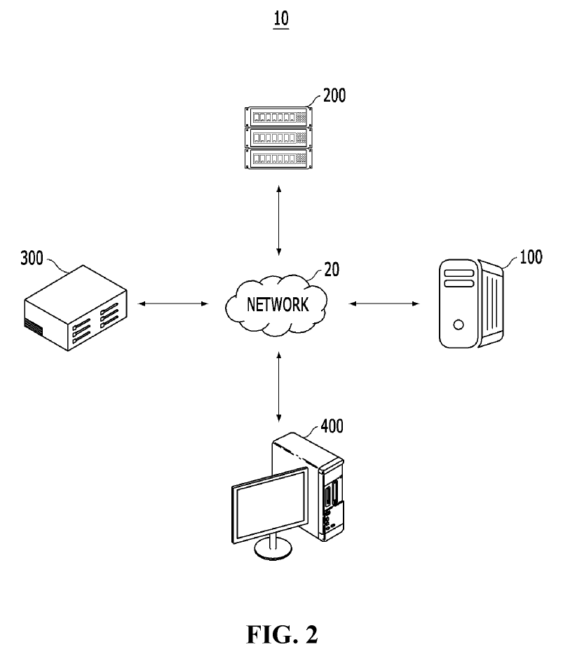

FIG. 2 is a schematic diagram of a streaming providing system according to an exemplary embodiment of the present disclosure.

Referring to FIG. 2, the streaming providing system 10 according to the exemplary embodiment of the present disclosure may include a streaming providing apparatus 100 using data for each frequency according to an exemplary embodiment of the present disclosure (hereinafter, referred to as a “streaming providing apparatus 100”), a main server 200, a sensor 300, and a client terminal 400.

The streaming providing apparatus 100, the main server 200, the sensor 300, and the client terminal 400 may communicate with each other via a network 20. The network 20 means a connection structure which allows information exchange between nodes such as terminals and servers. Examples of the network 20 may include a 3rd generation partnership project (3GPP) network, a long term evolution network, a 5G network, a world interoperability for microwave access (WIMAX) network, Internet, a local area network (LAN), a wireless local area network (wireless LAN), a wide area network (WAN), a personal area network (PAN), a Wi-Fi network, a Bluetooth network, a satellite broadcasting network, an analog broadcasting network, and a digital multimedia broadcasting (DMB) network, but are not limited thereto.

For example, the client terminal 400 may include all kinds of wireless communication devices such as a smart phone, a smart pad, a tablet PC, a personal communication system (PCS), a global system for mobile communication (GSM), a personal digital cellular (PDC), a personal handyphone system (PHS), a personal digital assistant (PDA), an international mobile telecommunication (IMT)-2000, a code division multiple access (CDMA)-2000, a W-code division multiple access (W-CDMA), and a wireless broadband internet (Wibro) terminal.

In the meantime, in the description of the exemplary embodiment of the present disclosure, the streaming is a technology of real-time transmission and implementation of data transmitted and received through the network 20 and may refer to a method that divides a specific input signal (for example, an audio signal or a video signal) into a plurality files, rather than a single form and are sequentially transmitted and reproduced.

That is, the input signal 1 may be divided into small segments to be transmitted in accordance with a speed of the network 20 to which the client terminal 400 is accessed. At this time, each segment may include header information to be connected to a data segment which will be subsequently transmitted. According to the streaming method, the client terminal 400 receives the data segment which is transmitted in real time and restores the data segment as an output signal 3 using an operating program, simultaneously, to output (reproduce) an output signal 3.

In the meantime, such a streaming service is configured by a server (referred to as a “main server 200” in the description of the exemplary embodiment of the present disclosure) and a client (referred to as a “client terminal 400” in the description of the exemplary embodiment of the present disclosure), and to aid better understanding, for example, an input signal, such as multimedia data, is transmitted from the server to the client and is reproduced by the client.

Further, an encoding server corresponding to the streaming providing apparatus 100 disclosed in the present disclosure performs a function of converting analog data received from equipment (referred to as a “sensor 300” in the description of the exemplary embodiment of the present disclosure), such as a camcorder or a microphone, into digital data using a compression technique. When the analog data is converted into digital data, the streaming providing apparatus 100 disclosed in the present disclosure may operate to derive the digital data as a signal 2 for each frequency including a component for a predetermined frequency band.

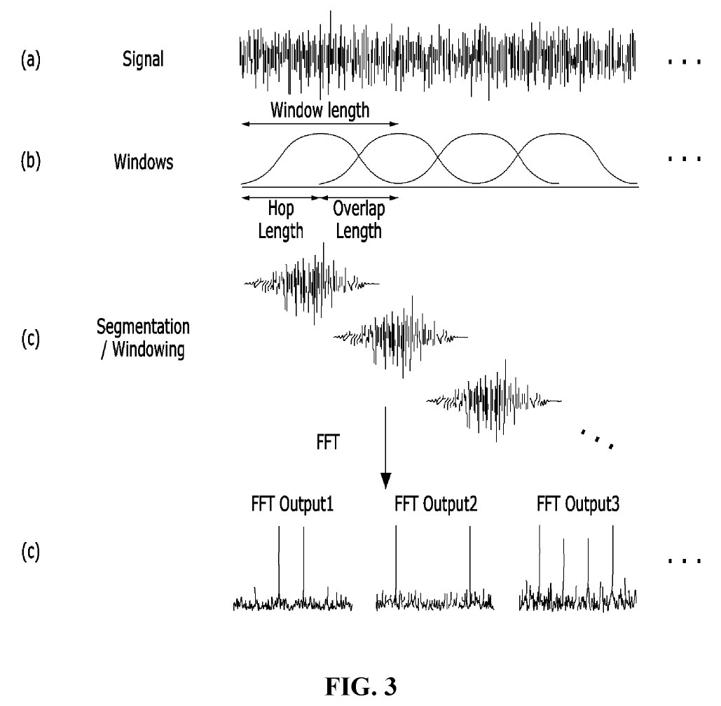

FIG. 3 is a conceptual view illustrating an operation process of a streaming providing apparatus using data for each frequency according to an exemplary embodiment of the present disclosure.

Referring to FIG. 3, the streaming providing apparatus 100 may apply a window to an analog input signal 1 having a temporal continuity to perform window-based segmentation to convert the input signal 1 into a signal 2 for each frequency.

Further, target data in the form of a stream including the signal 2 for each frequency converted by the streaming providing apparatus 100 disclosed in the present disclosure may be transmitted to the main server 200 which is provided to provide streaming to the client terminal 400. In other words, signals for each frequency (‘FFT Output 1’, ‘FFT Output 2’, and ‘FFT Output 3’ in FIG. 3) converted from the analog input signal 1 by the streaming providing apparatus 100 disclosed in the present disclosure may be directly utilized as a data stream to provide the streaming using the target data through the client terminal 400.

With regard to this, an analog signal, such as an audio signal, is formed of a plurality of single frequency components and Fourier transform may be applied to decompose the signal into individual frequencies and amplitudes corresponding to the corresponding frequency to convert the signal from a time domain into a frequency domain. According to this conversion, the analog signal (for example, an audio signal) may be decomposed into a sum of a cosine wave and a sine wave.

Specifically, in an audio clip, amplitudes of different frequency waves vary over time. Accordingly, some patches may include only a high frequency wave with a large amplitude and the other patches of the same clip may include only a low frequency wave with a large amplitude. At this time, a spectrum derived as the Fourier transform result of the entire audio is averaged for the entire clips so that basically, it has an average amplitude for the low frequency and the high frequency.

In contrast, Fourier transform corresponding to an audio patch obtained by dividing an original clip by a fixed time interval may be computed and such an FFT set correctly represents local information so that more information about changed matters in the original clip may be provided.

Further, as illustrated in FIG. 3, according to short-time Fourier transform (STFT), an analog signal corresponding to a relatively long sequence is divided into a short segment having the same length and then Fourier transform is individually performed on each divided segment. A length (size) of the window applied for STFT refers to a fixed interval at which the analog signal is divided by the STFT and a hop length refers to a length of a part of the window length which does not overlap, and an overlap length refers to a length of an overlapping part of the window.

Hereinafter, the specific function and operation of the streaming providing apparatus 100 will be described in detail.

The streaming providing apparatus 100 may acquire an input signal 1.

To be more specific, in the description of the exemplary embodiment of the present disclosure, the input signal 1 may broadly include various analog signals which are measured by various sensors 300 and have temporal continuity, such as audio (sound) data, video (image) data, oscillation data, wave data, temperature data, and point clouds.

Further, the streaming providing apparatus 100 may convert the applied input signal 1 into a signal 2 for each frequency.

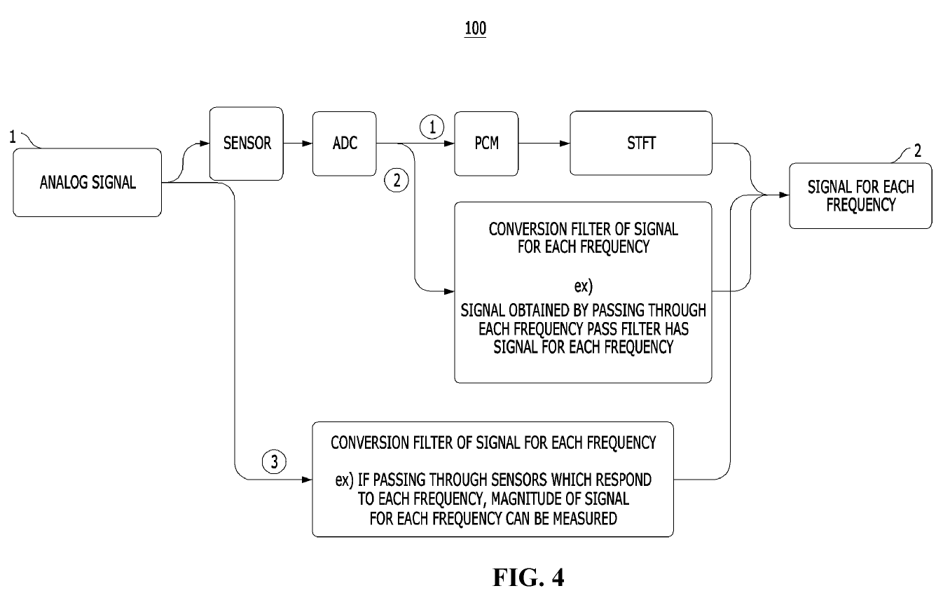

FIG. 4 is a conceptual view for explaining a process of converting an analog input signal into a signal for each frequency.

Referring to FIG. 4, for example, the streaming providing apparatus 100 may sample a sensor signal generated by a sensor 300 which is provided to measure an analog signal into a digital signal using an analog-to-digital converter (ADC).

Further, referring to (1) of FIG. 4, the streaming providing apparatus 100 may apply pulse-code modulation (PCM) to the sampled digital signal. Further, the streaming providing apparatus 100 may perform a reference transform that decomposes a signal to which the pulse-code modulation is applied into a component according to a predetermined frequency band.

Further, referring to (2) of FIG. 4, the streaming providing apparatus 100 may pass a digital signal through a signal conversion filter which derives a signal for each frequency using a digital signal sampled by the ADC. For example, a signal obtained by passing the sampled digital signal into the band pass filter (BPF) corresponding to the predetermined frequency band may be formed of a signal component for each frequency and the signal which has passed through the band pass filter may become the signal 2 for each frequency.

As another example, referring to (3) of FIG. 4, the streaming providing apparatus 100 may generate the signal 2 for each frequency based on a result obtained by measuring a magnitude for each frequency band of the input signal 1 which is generated by passing through the sensor 300 provided so as to respond to a plurality of predetermined frequency bands.

To be more specific, according to an implemented example of the present disclosure, the sensor 300 may be formed of unit sensor modules which respond to the predetermined frequency and the magnitude of the signal for each frequency may be measured by the unit sensor modules, and a signal which passes through the individual unit sensor module may be derived as the signal 2 for each frequency.

Further, the streaming providing apparatus 100 may transmit target data in the form of a stream including the converted signal 2 for each frequency to the main server 200 which provides streaming for the client terminal 400.

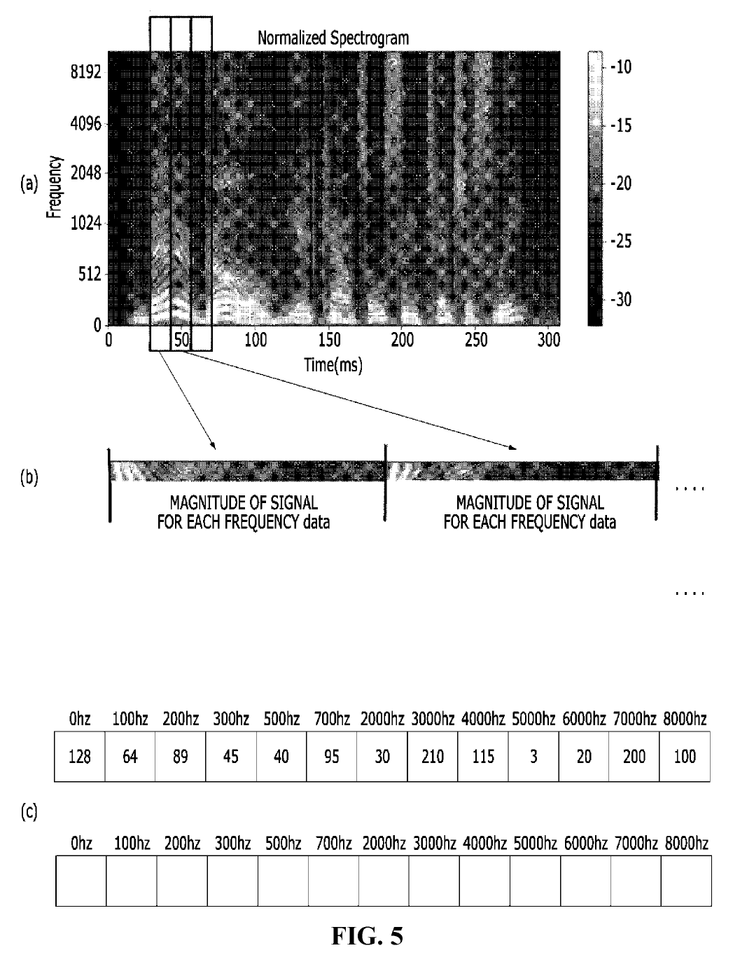

In summary, the streaming providing apparatus 100 disclosed in the present disclosure may convert an applied input signal into a signal for each frequency through various signal processing routes, by a method that a digital signal directly passes through a filter for each frequency band to be converted into a signal for each frequency, rather than being converted into a PCM signal in a digital converter which is applied to cochlear implants, and a method that an analog signal is immediately converted into a signal for each frequency via a sensor which is sensitive to the frequency, without passing through a general sensor or the ADC, similar to the process of actually transmitting an auditory signal in a human body, as well as a normal signal processing method which generates a signal for each frequency band through sampling-modulation-frequency domain conversion. Therefore, an optimal signal processing method may be customized according to various application fields and requirements and the signal processing performance may be improved from various aspects, such as latency, accuracy, and energy efficiency, by utilizing the advantages of the first to third conversion methods described above. FIG. 5 is a conceptual view for explaining stream type target data including a converted signal for each frequency.

Referring to FIG. 5, s spectrogram may be used to represent the signal 2 for each frequency which is derived by the reference transform, such as STFT. For example, in the signal represented in the form of spectrogram, a vertical axis may represent a frequency component (for example, a frequency of a log domain) and a horizontal axis may represent a time length of a window used to calculate the STFT. Each pixel value (in other words, a value of (x, y) which forms the spectrogram may represent a specific window length (time) and an amplitude (for example, in the unit of dB) corresponding to a specific frequency.

Further, referring to FIG. 5, stream data corresponding to the signal 2 for each frequency included in the target data may be data in which spectrogram data is one-dimensionally disposed.

For example, if a unit section (for example, a window length) which is set in advance to generate stream data is 15 ms, two stream data illustrated in a lower portion of FIG. 5 may be individually generated using signal magnitude data for each frequency to a first section (for example, 30 to 45 ms) and signal magnitude data for each frequency to a second section (for example, 45 to 60 ms).

Further, referring to FIG. 5, the streaming providing apparatus 100 may quantize the signal magnitude data for each frequency which is derived in each predetermined unit section to int-type data or float-type data to generate target data. For example, in a space of each stream data illustrated in the lower portion of FIG. 5, a signal magnitude within a predetermined threshold signal magnitude (for example, 0 to 8192 Hz) may be quantized and filled.

Further, the streaming providing apparatus 100 may perform preprocessing on the target data to be transmitted to the main server 200 to remove a noise component. With regard to this, during the preprocessing for removing the noise component of the target data, since the target data is formed of a signal 2 for each frequency, the preprocessing algorithm may be performed without a separate frequency conversion (for example, additional STFT) processing so that the latency may be drastically reduced as compared with the method of the related art which transmits the PCM data to the main server 200 or the client terminal 400.

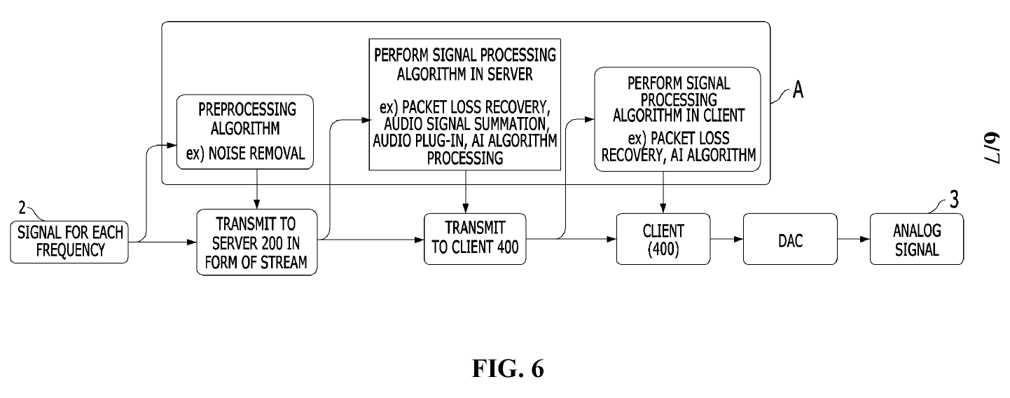

FIG. 6 is a conceptual view for explaining a streaming providing process using target data.

Referring to FIG. 6, the target data which is transmitted to the main server 200 in the form of stream may be transmitted from the main server 200 to the client terminal 400 to be reconstructed as an analog output signal 3 and output through the client terminal 400. To this end, the client terminal 400 may include a digital-to-analog converter (DAC) module to reconstruct the target data into an analog signal.

Further, referring to the reference numeral A of FIG. 6, the main server 200 may apply a first signal processing algorithm to the target data to be transmitted to the client terminal 400.

For example, the first signal processing algorithm may include packet loss recovery for target data and artificial intelligence-based algorithm processing (for example, deep learning model-based inference). Further, if the input signal 1 and the output signal 3 are audio signals, the first signal processing algorithm may include a summation processing, an audio plug-in processing, etc. for the audio signals.

With regard to this, when a first signal processing algorithm is applied to the target data, since the target data is formed of a signal 2 for each frequency, the first signal processing algorithm may be performed without a separate frequency conversion (for example, additional STFT) processing so that the latency may be drastically reduced as compared with the method of the related art which transmits the PCM data to the main server 200 or the client terminal 400.

In other words, according to the streaming providing system 10 disclosed in the present disclosure, when the signal processing algorithm (first signal processing algorithm) at the main server 200 stage is applied, an additional reference transform to decompose the target data into a component according to each frequency band may be omitted.

Further, referring to the reference numeral A of FIG. 6, the client terminal 400 which acquires the target data from the main server 200 may apply a second signal processing algorithm to the target data.

For example, the second signal processing algorithm may include packet loss recovery for target data and artificial intelligence-based algorithm processing (for example, deep learning model-based inference).

With regard to this, when a second signal processing algorithm is applied to the target data, since the target data is formed of a signal 2 for each frequency, the second signal processing algorithm may be performed without a separate frequency conversion (for example, additional STFT) processing so that the latency may be drastically reduced as compared with the method of the related art which transmits the PCM data to the main server 200 or the client terminal 400.

In other words, according to the streaming providing system 10 disclosed in the present disclosure, when the signal processing algorithm (second signal processing algorithm) at the client terminal 400 stage is applied, an additional reference transform to decompose the target data into a component according to each frequency band may be omitted.

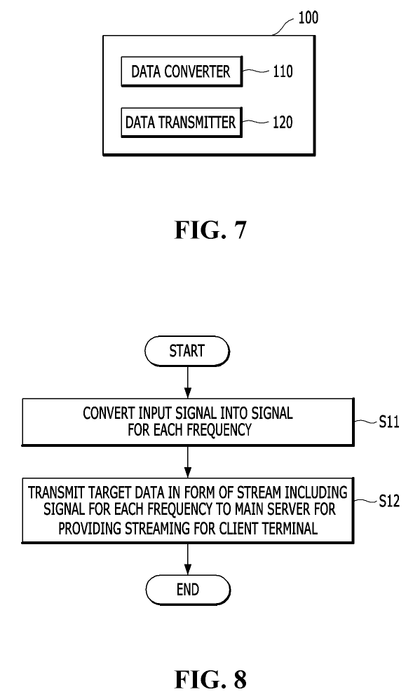

FIG. 7 is a schematic diagram of a streaming providing apparatus using data for each frequency according to an exemplary embodiment of the present disclosure.

Referring to FIG. 7, the streaming providing apparatus 100 may include a data converter 110 and a data transmitter 120.

The data converter 110 may convert the input signal 1 into a signal 2 for each frequency.

For example, the data converter 110 may sample a sensor signal generated by a sensor 300 which is provided to measure an analog signal into a digital signal using an analog-to-digital converter.

Further, according to the exemplary embodiment of the present disclosure, the data converter 110 may apply pulse-code modulation (PCM) to the sampled digital signal. Further, the data converter 110 may perform a reference transform that decomposes a signal to which the pulse-code modulation is applied into a component according to a predetermined frequency band.

Further, according to another exemplary embodiment of the present disclosure, the data converter 110 may allow the digital signal to pass through a signal conversion filter which derives the signal for each frequency using the digital signal.

As another example, the data converter 110 may generate the signal 2 for each frequency based on a result obtained by measuring a magnitude for each frequency band of the input signal 1 which is generated by passing through the sensor 300 provided so as to respond to a plurality of predetermined frequency bands.

The data transmitter 120 may transmit target data in the form of a stream including the converted signal 2 for each frequency to the main server 200 which provides streaming for the client terminal 400.

Further, the data transmitter 120 may perform preprocessing on the target data to be transmitted to the main server 200 to remove a noise component.

Hereinafter, an operation flow of the present disclosure will be described in brief based on the above detailed description.

FIG. 8 is an operation flowchart for a streaming providing method using data for each frequency according to an exemplary embodiment of the present disclosure.

The streaming providing method using data for each frequency illustrated in FIG. 8 may be performed by the above-described streaming providing apparatus 100. Therefore, even though some contents are omitted, the contents which have been described for the streaming providing apparatus 100 may be applied to the description of the streaming providing method using data for each frequency in the same manner.

Referring to FIG. 8, in step S11, the data converter 110 may convert the input signal 1 into a signal 2 for each frequency.

For example, in step S11, the data converter 110 may sample a sensor signal generated by a sensor 300 which is provided to measure an analog signal into a digital signal using an analog-to-digital converter.

Further, according to the exemplary embodiment of the present disclosure, in step S11, the data converter 110 may apply pulse-code modulation (PCM) to the sampled digital signal.

Further, in step S11, the data converter 110 may perform a reference transform that decomposes a signal to which the pulse-code modulation is applied into a component according to a predetermined frequency band. With regard to this, for example, in step S11, the data converter 110 may apply the reference transform including short-time Fourier transform (STFT).

Further, according to another exemplary embodiment of the present disclosure, in step S11, the data converter 110 may allow the digital signal to pass through a signal conversion filter which derives the signal for each frequency using the digital signal.

As another example, in step S11, the data converter 110 may generate the signal 2 for each frequency based on a result obtained by measuring a magnitude for each frequency band of the input signal 1 which is generated by passing through the sensor 300 provided so as to respond to a plurality of predetermined frequency bands.

Next, in step S12, the data transmitter 120 may transmit target data in the form of a stream including the converted signal 2 for each frequency to the main server 200 which provides streaming for the client terminal 400.

Further, in step S12, the data transmitter 120 may perform preprocessing on the target data to be transmitted to the main server 200 to remove a noise component.

In the above description, steps S11 and S12 may be further divided into additional steps or combined as smaller steps depending on an implementation example of the present disclosure. Further, some steps may be omitted if necessary and the order of steps may be changed.

The streaming providing method using data for each frequency according to the exemplary embodiment may be implemented as a program command which may be executed by various computer means to be recorded in a computer readable medium. The computer readable medium may include solely a program command, a data file, and a data structure or a combination thereof. The program commands recorded in the medium may be specifically designed or constructed for the present disclosure or known to those skilled in the art of a computer software to be used. Examples of the computer readable recording medium include magnetic media such as a hard disk, a floppy disk, or a magnetic tape, optical media such as a CD-ROM or a DVD, magneto-optical media such as a floptical disk, and a hardware device which is specifically configured to store and execute the program command such as a ROM, a RAM, and a flash memory. Examples of the program command include not only a machine language code which is created by a compiler but also a high level language code which may be executed by a computer using an interpreter. The hardware device may operate as one or more software modules in order to perform the operation of the present disclosure and vice versa.

Further, the above-described streaming providing method using data for each frequency may also be implemented as a computer program or an application executed by a computer which is stored in a recording medium.

The above description of the present disclosure is illustrative only and it is understood by those skilled in the art that the present disclosure may be easily modified to another specific type without changing the technical spirit of an essential feature of the present disclosure. Thus, it is to be appreciated that exemplary embodiments described above are intended to be illustrative in every sense, and not restrictive. For example, each component which is described as a singular form may be divided to be implemented and similarly, components which are described as a divided form may be combined to be implemented.

The scope of the present disclosure is represented by the claims to be described below rather than the detailed description, and it is to be interpreted that the meaning and scope of the claims and all the changes or modified forms derived from the equivalents thereof come within the scope of the present disclosure.

1. A method for providing streaming by using data for each frequency, comprising the steps of:
converting an input signal into a signal for each frequency; and
transmitting target data in a form of stream including the signal for each frequency to a main server for providing streaming for a client terminal,
wherein the target data is transmitted from the main server to the client terminal to be reconstructed as an analog signal.

2. The method for providing streaming of claim 1, wherein the step of converting includes:
a step of sampling a sensor signal generated by a sensor provided to measure the analog signal into a digital signal using an analog-to-digital converter.

3. The method for providing streaming of claim 2, wherein the step of converting further includes:
a step of applying pulse-code modulation (PCM) to the digital signal; and
a step of performing a reference transform to decompose a signal to which the pulse-code modulation is applied to a component according to a predetermined frequency band.

4. The method for providing streaming of claim 3, wherein the reference transform includes short-time Fourier transform (STFT).

5. The method for providing streaming of claim 2, wherein the step of converting further includes a step of allowing the digital signal to pass through a signal conversion filter which derives the signal for each frequency, by using the digital signal.

6. The method for providing streaming of claim 1, wherein in the step of converting, the signal for each frequency is generated based on a result of measuring a magnitude for each frequency band of the input signal which is generated by passing through a sensor provided so as to respond to each of the plurality of predetermined frequency bands.

7. The method for providing streaming of claim 1, further comprising:
before the step of transmitting to the main server,
a step of performing preprocessing on the target data to remove a noise component.

8. The method for providing streaming of claim 1, wherein the main server applies a predetermined signal processing algorithm to the target data to be transmitted to the client terminal and when the signal processing algorithm is applied, a reference transform which decomposes the target data into a component according to each frequency band is omitted.

9. The method for providing streaming of claim 1, wherein the client terminal applies a predetermined signal processing algorithm to the target data received from the main server and when the signal processing algorithm is applied, a reference transform which decomposes the target data into a component according to each frequency band is omitted.

10. An apparatus for providing streaming by using data for each frequency, comprising:
a data converter which converts an input signal into a signal for each frequency; and
a data transmitter which transmits target data in a form of stream including the signal for each frequency to a main server for providing streaming for a client terminal,
wherein the target data is transmitted from the main server to the client terminal to be reconstructed as an analog signal.

11. The apparatus for providing streaming of claim 10, wherein the data converter samples a sensor signal generated by a sensor provided to measure the analog signal into a digital signal using an analog-to-digital converter.

12. The apparatus for providing streaming of claim 10, wherein the data converter samples a sensor signal generated by a sensor provided to measure the analog signal into a digital signal using an analog-to-digital converter and applies pulse-code modulation (PCM) to the digital signal, and then performs a reference transform which decomposes a signal to which the pulse-code modulation is applied into a component according to a predetermined frequency band, or allows the digital signal to pass through a signal conversion filter which derives the signal for each frequency using the digital signal.
